(19) United States
(12) Patent Application Publication
(10) Pub. No.: US 2005/0023084 A1
(43) Pub. Date: Feb. 3, 2005

(54) Safety device

(76) Inventor: Mark J. Lazarus, Brentwood (GB)

Correspondence Address: WOOD, PHILLIPS, KATZ, CLARK & MORTIMER, 500 W. MADISON STREET, SUITE 3800, CHICAGO, IL, 60661, US

(21) Appl. No.: 10/638,735

(22) Filed: Aug. 11, 2003

(30) Foreign Application Priority Data
Aug. 9, 2002 (GB) 0218577.5

(51) Int. Cl. E06C 7/42

(52) U.S. Cl. 182/214; 182/107

(57) ABSTRACT

A safety device for a ladder comprising means to receive at least one arm of a ladder in use, and an extendable supporting member projecting from the or each receiving means. The supporting member engaging a surface to which the ladder is directed.

The present invention relates to a safety device and more specifically to a safety device for use with a ladder.

Many people, particularly tradesmen, use ladders daily to reach items high off the ground, or to work at a high level. It is often the case that the position at which the ladder can be leant against a wall is limited, resulting in the need for a person on the ladder to reach over to one side. Leaning to one side whilst on a ladder can cause the ladder to tilt against the wall making it highly unstable and, in some cases, causing the person on the ladder to fall off.

Instability of the ladder is a particular problem for window cleaners or window installers where the arms of the ladder cannot be placed heavily against the window for the risk of causing damage to or breakage of the glass. Instead, the arms of the ladder have to engage the wall to one side of the window area. This results in the need for the person on the ladder to stretch over to reach certain areas requiring work. Furthermore, to complete all the work required, the ladder needs to be continually re-positioned to reach every area requiring work.

The present invention seeks to alleviate the aforementioned problems.

According to a first aspect of the present invention, there is provided an attachment for a ladder, the attachment comprising means to receive at least one arm of a ladder in use, and an extendable supporting member of square cross-section projecting from the receiving means, the supporting member engaging, in use, with a surface to which the ladder is directed and, in use, maintaining a gap between said surface and the ladder.

Preferably the attachment comprises a separate receiving means associated with each arm of the ladder.

Preferably still, the supporting member projects in a sideways direction from the or each receiving means with respect to the ladder.

Advantageously, the supporting member includes at least one extension section capable of sliding within and extending from at least one end of the supporting member. Preferably, the or each extension has a squarc cross section.

In a preferred embodiment, the supporting member further comprises a L-shaped end member slidable within and extendable from at least one end of the supporting member. The L-shaped member preferably has a rubber stay attached to an end thereof.

It is preferable that the or each supporting member engages with the surface at a point located at a side of the ladder.

the support member preferably includes attachment means to detachably attach an object to the or each support means.

According to a second aspect of the present invention, there is provided an attachment for a ladder, the attachment comprising means to receive at least one arm of a ladder in use, and an extendable supporting member of square cross-section pivotally attached to and extending from the receiving means, the supporting member engaging, in use, with a surface to which the ladder is directed and, in use, maintaining a gap between said surface and the ladder.

One embodiment of the present invention will now be described, by way of example, with reference to the accompanying Figures, in which:

FIG. 1 is a perspective view of a first embodiment of a safety device constructed in accordance with the present invention;

FIG. 2 is a perspective view of the safety device of FIG. 1 in use, attached to a ladder;

FIG. 3 is a perspective view from above of the safety device of FIG. 2;

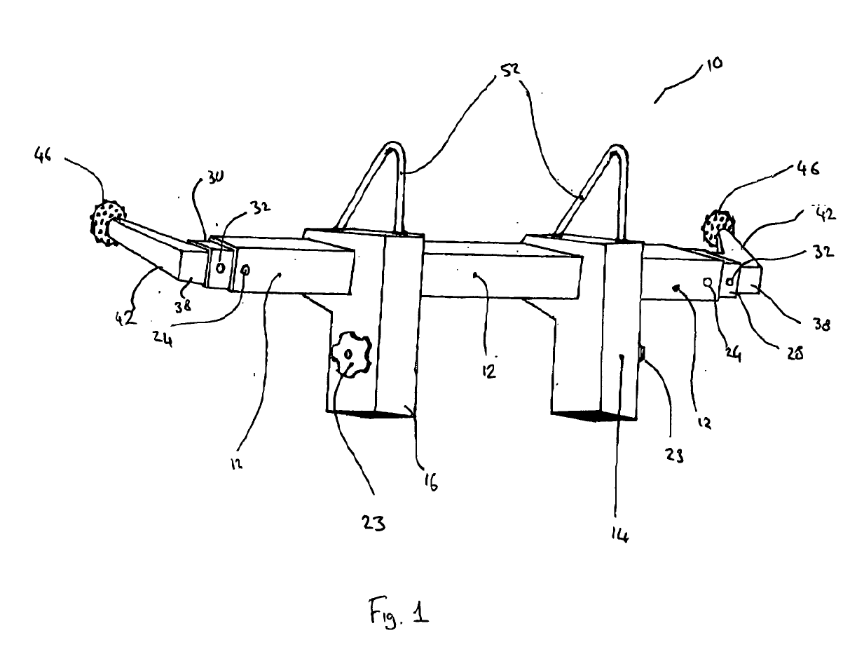

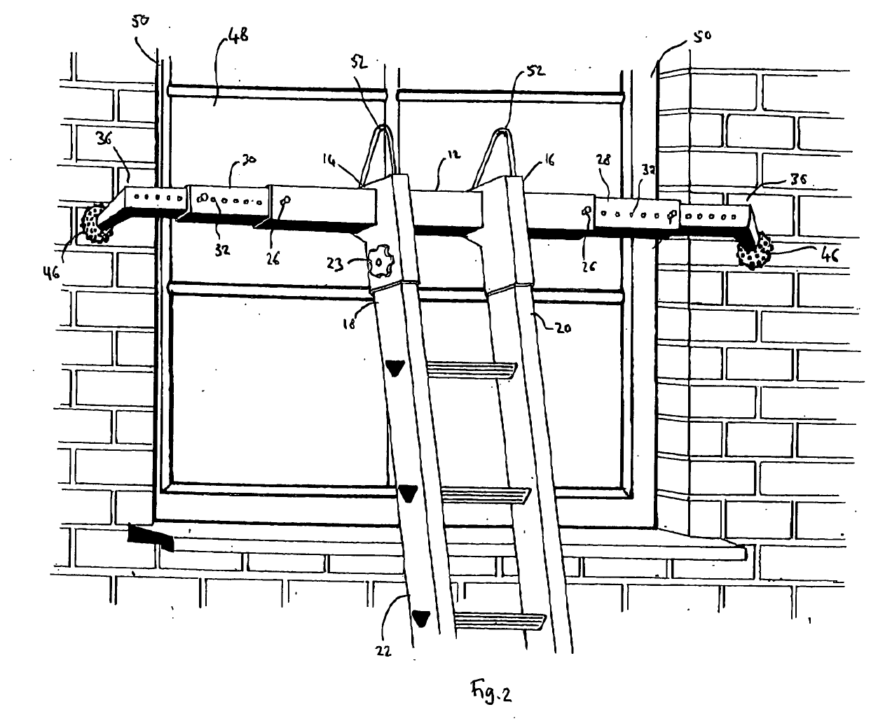

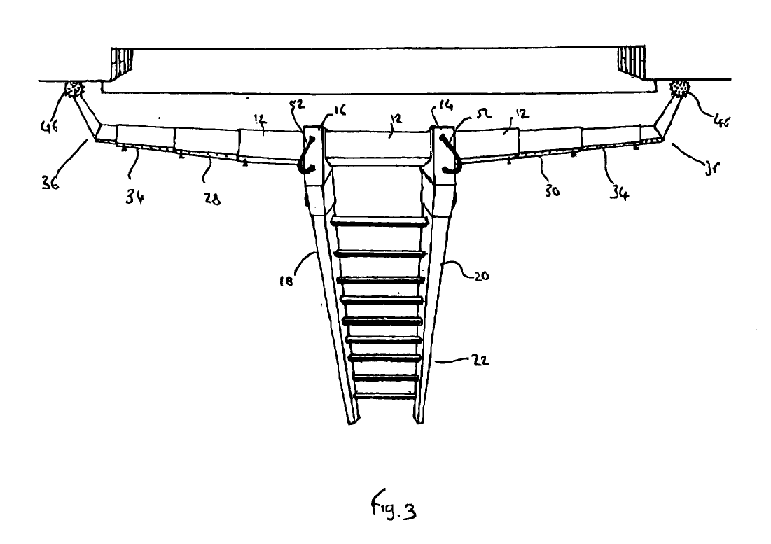

FIG. 4 is a plan view of one arm of the safety device of FIG. 1 with two extension sections;

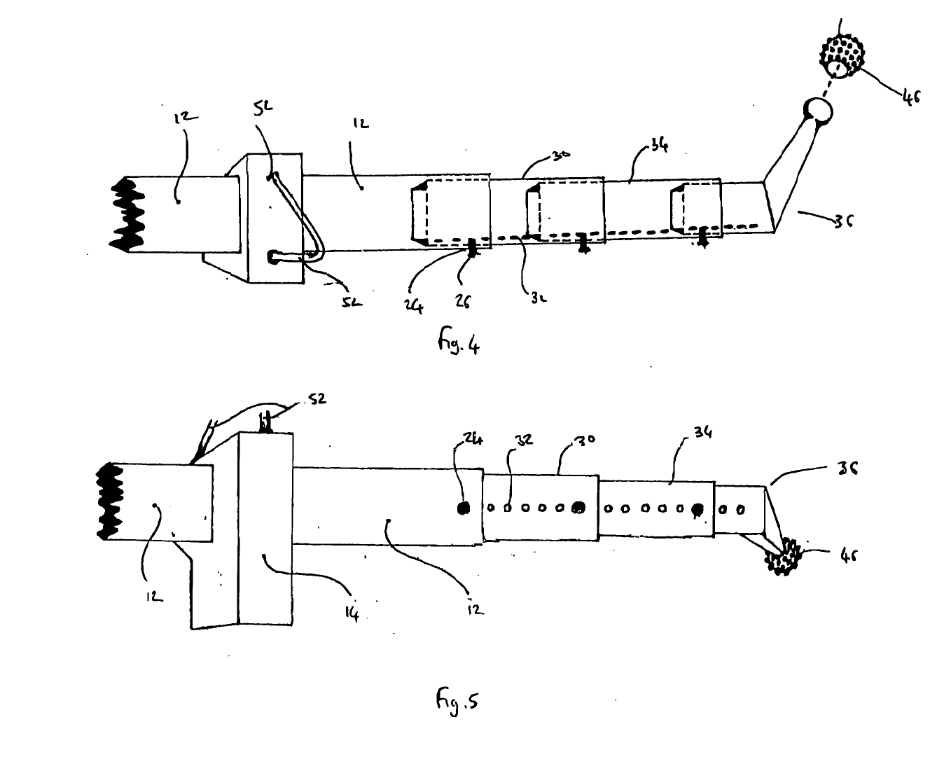

FIG. 5 is a side view of the aim of FIG. 4;

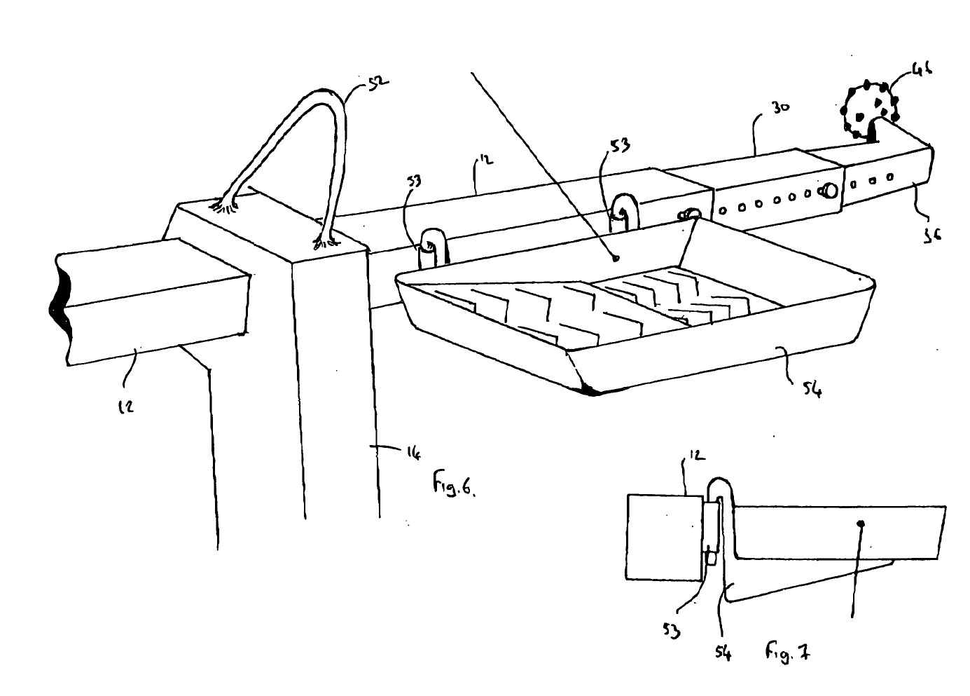

FIG. 6 is a perspective view of one arm of the safety device of FIG. 1 incorporating a paint tray;

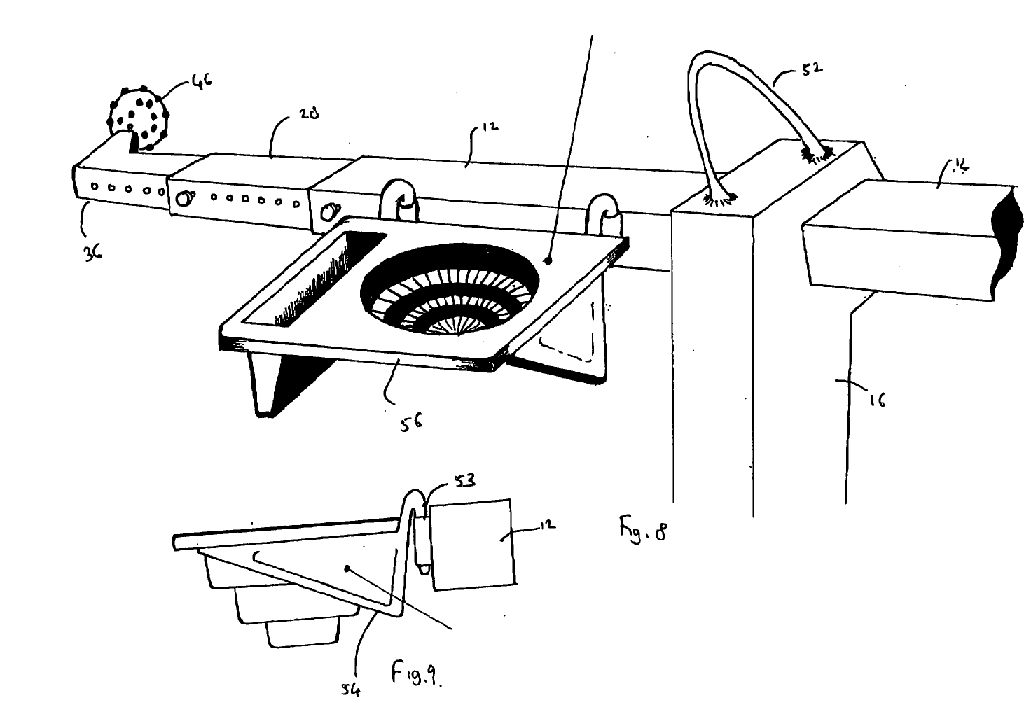

FIG. 7 is a side view of the attachment mechanism of the arm and paint tray of FIG. 6;

FIG. 8 is a perspective view of one arm of the safety device of FIG. 1 incorporating a paint pot holder;

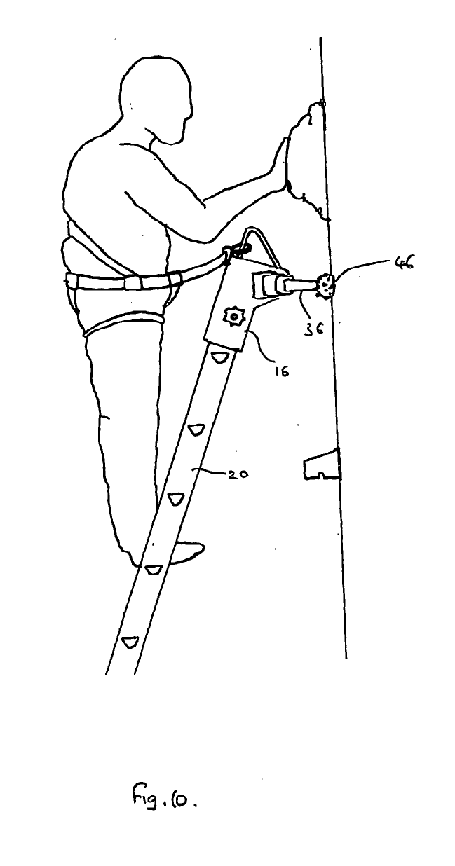

FIG. 9 is a side view of the attachment mechanism of the arm and paint pot holder of FIG. 8;

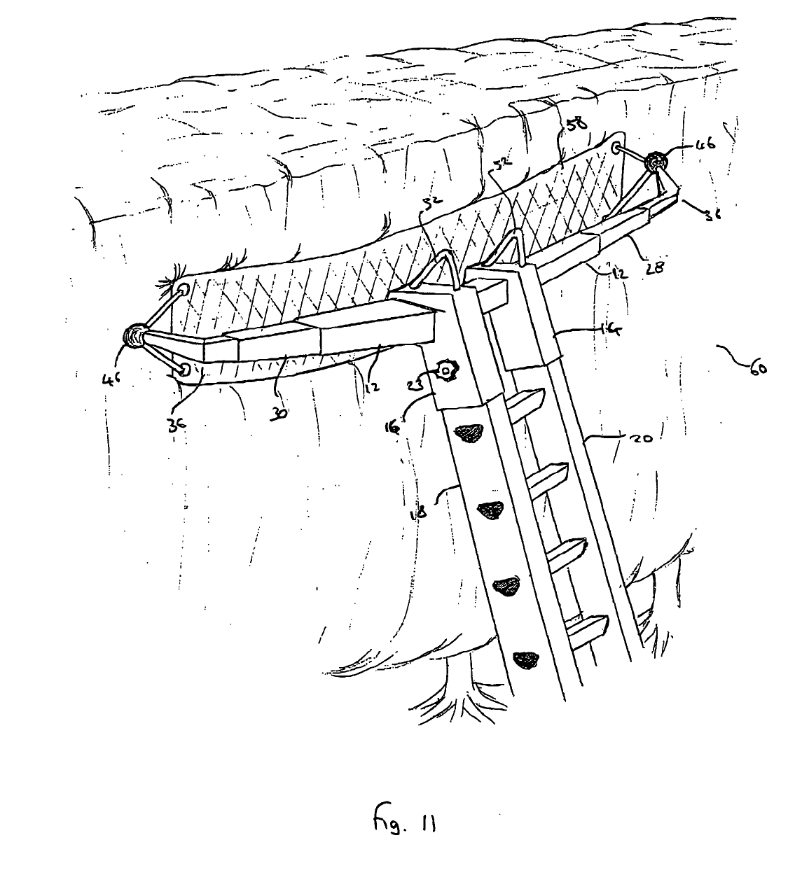

FIG. 10 is a side view of the safety device and ladder in use incorporating a harness attachment;

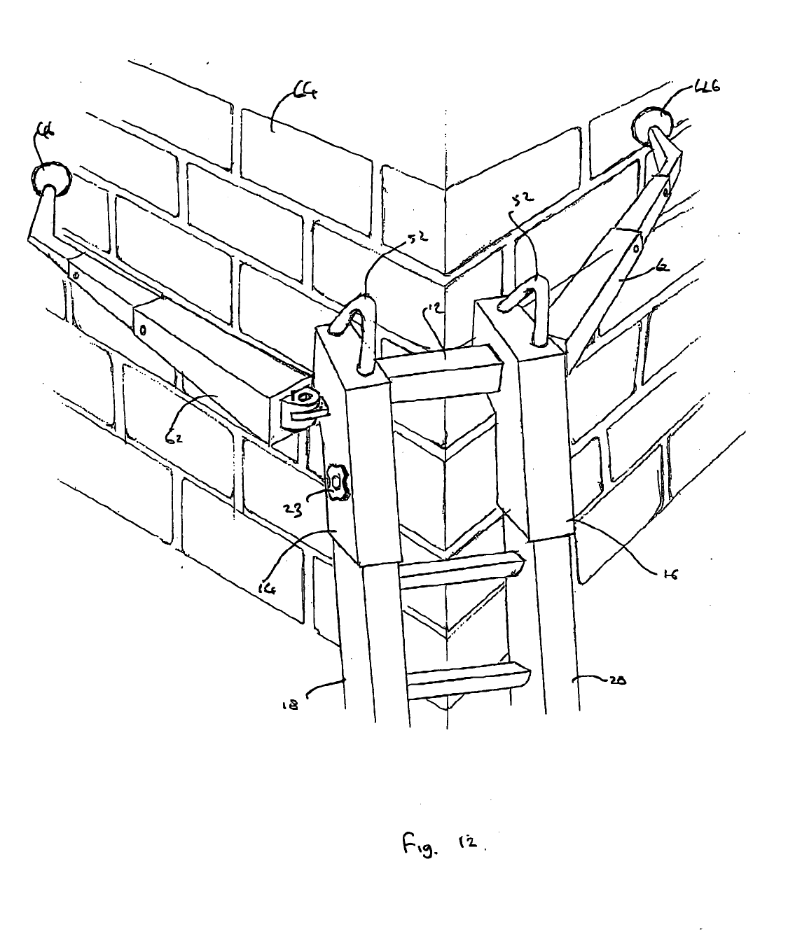

FIG. 11 is a perspective view of the safety device of FIG. 1 incorporating a hedge strap support; and

FIG. 12 is a perspective view of a second embodiment of a safety device constructed in accordance with the present invention.

Referring first to FIG. 1, the safety device 10 comprises a support member 12 on which are located two sleeve members 14, 16.

The sleeve members 14, 16 are each closed at one end, the other end being and are designed to receive the ends of respective arms 18, 20 of a ladder 22 (see FIG. 2).

A screw handle tightener 23 is attached to a side of each sleeve member 12, 14 to press against the ladder arms 18, 20 thereby to secure the ladder arms 18, 20 securely within the sleeve members 14, 16 of the safety device 10.

The support member 12 comprises an elongate hollow box section of square cross-section. The sleeve members 14, 16 are located on the support member 12 at positions such that the support member 12 extends between the sleeve members 14, 16 and beyond each sleeve member 14, 16. Apertures 24 are formed in a side wall at both ends of the support member 12. The apertures 24 are designed to receive pins 26.

Telescopic extension sections 28, 30 are located at either end of the support member 12. Each extension 28, 30 has the same profile as the support member 12 but is of smaller dimension thus allowing the extensions 28, 30 to slide within the ends of the support member 12. A plurality of apertures 32 extend along part of, or the entire length of, the extension sections. The apertures 32 are also designed to receive pins 26 such that the extensions 28, 30 can be extended from either side of the support member 12 by pre-determined amounts.

As can be seen in FIGS. 3, 4 and 5, further extensions sections 34 can be slidable within the ends of each extension 28, 30 and can be extended by pre-determined amounts from their neighboring extensions in the same way. For the purposes of clarity, the rest of this description will only refer to a single extension member 28, 30.

A respective end member 36 is located at the free end of each of the extension sections 28, 30. Each end member 36 is generally L-shaped. One arm 38 of each L-shaped end member 36 is generally the same profile as the extension sections 28, 30 but is of smaller dimension thus allowing that arm 38 of the associated L-shaped end member 26 to slide within the free end of the associated extension section 28, 30 and to extend therefrom by a pre-determined amount via the same aperture/pin mechanism 40 as detailed above.

The other arm 42 of each L-shaped end member 36 has a rubber stay 46 located at the end thereof.

The rubber stays 46 provide grip when the end members 36 are directed against a wall to which the ladder 22 is directed. The support member 12, the extension sections 28, 30 and the end members 36 each have a square cross-section so that the weight of a person on the ladder 22, in use, is evenly distributed across the entire support thereby avoiding bowing or other failure of the support member 12 or extension parts which would otherwise cause the ladder 22 to become unstable.

As can be seen in FIG. 2, the safety device 10 allows the ladder 22 to be directed over the middle of a window 48, for example, wherein the contact points of the end members 36 can be extended to either side of the window frame 50.

Handles 52 are located on, and upstand from, a top surface of each sleeve member 12, 14.

The handles 52 are able to act as connection points for a harness which may be worn by a user of the ladder 22 incorporating the safety device 10 (see FIG. 11) to prevent the user from falling off the ladder 22.

In a further embodiment, shown in FIGS. 6 to 9, the support member 12 has at least one tubular socket 53 to receive an arm or arms of a base member 54 providing a base for, for example, a paint tray 54 (FIG. 7) or a paint pot holder 56 (FIG. 9).

In a further embodiment (not shown) a shelf or a work top is detachably attached to an arm of the safety device 10 in the manner as described in any of the previous embodiments.

FIG. 11 shows the safety device described above incorporating a hedge strap support 58. Here, the hedge strap support 58 comprises an flexible strap attached at either end to, and extending between, the rubber stays 46 of the L-shaped members 36.

With the aid of the hedge strap support 58, the ladder 22 can be placed up against a hedge 60, for example, whereby the strap support 58 extends along part of the hedge 60 retaining the ladder 22 against the hedge 60 and maintaining its stability.

A second embodiment of the safety device 10 of the present invention can be seen in FIG. 12.

Here, the support member 12 extends only between the sleeve members 14, 16 of the safety device 10. Further supporting arms 62 are pivotally attached to the other sides of both the sleeve members 14, 16. The supporting arms 62 comprise elongate hollow box sections of square cross-section. Extensions sections and end sections extend from the supporting arms in the same manner as described above.

The fact that each supporting arm 62 is pivotable about its respective sleeve member 14, 16 allows for the safety device 10 to be used on the comer of a wall 64 as can be seen in FIG. 12. This allows a ladder 22 directed towards to the corner to be maintained in position and to remain stable. A locking mechanism (not shown) is provided on both pivotal connections to prevent the supporting arms 62, and hence their associated extensions and end members from pivoting away from the wall 64 parts to which they are directed.

1. An attachment for a ladder, the attachment comprising means to receive at least one arm of a ladder in use, and an extendable supporting member of square cross-section projecting from the receiving means, the supporting member engaging, in use, with a surface to which the ladder is directed and, in use, maintaining a gap between said surface and the ladder.

2. An attachment according to claim 1, having a supporting member associated with each arm of the ladder.

3. An attachment according to claim 1, comprising a separate receiving means associated with each arm of the ladder.

4. An attachment according to any of claim 1, wherein the or each supporting member projects in a sideways direction from the respective receiving means with respect to the ladder.

5. An attachment according to claim 4, wherein the or each supporting member includes at least one extension section capable of sliding within, and extending from, at least one end of that supporting member.

6. An attachment according to claim 5, wherein the or each extension has a square cross-section.

7. An attachment according to claim 6, wherein the or each supporting member further comprises an L-shaped end member slidable within, and extendable from, at least one end of that supporting member.

8. An attachment according to claim 7, wherein the or each L-shaped member has a rubber stay attached to an end thereof.

9. An attachment according to claim 1, wherein the arrangement is such that, in use, the or each supporting member engages with the surface at a point located at a side of the ladder.

10. An attachment according to claim 1, wherein the or each supporting member includes attachment means for detachably attaching an object to that supporting means.

11. An attachment according to claim 1, wherein the or each supporting member is pivotally attached to and extends from, the respective receiving means.

12. An attachment for a ladder, the attachment comprising means to receive at least one arm of a ladder in use, and an extendable supporting member of square cross-section pivotally attached to, and extending from, the receiving means, the supporting member engaging, in use, with a surface to which the ladder is directed and, in use, maintaining a gap between said surface and the ladder.
